(19) United States
(12) Patent Application Publication
(10) Pub. No.: US 2014/0013200 A1
(43) Pub. Date: Jan. 9, 2014

(54) VIDEO COMMENT FEED WITH PRIORITIZATION

(71) Applicant: Eric Foster WHITE, Littleton, CO (US)

(72) Inventor: Eric Foster WHITE, Littleton, CO (US)

(73) Assignee: Mobitude, LLC, a Delaware LLC, Littleton, CO (US)

(21) Appl. No.: 13/544,911

(22) Filed: Jul. 9, 2012

(51) Int. Cl. G06F 17/00

(52) U.S. Cl. 715/230

(57) ABSTRACT

Comments are displayed in conjunction with a video or other content. A submitted reference point in the video is recorded when a viewer submits a comment. The submitted comment is added to a comment feed at the reference point if no existing comment is displayed at that point already. If an existing comment is already displayed at the reference point, at least one type of the submitted comment is compared to at least one type of the existing comment to produce a comparison result. Based on the comparison result, the submitted comment can be given priority over the existing comment, which can be moved, deleted or otherwise modified so that the submitted comment can be shown at the reference point in the comment feed.

### BACKGROUND

Many websites allow users to view or playback content such as video, audio, or multimedia. Users may also comment about the video using a forum that may be visible while playback of the content occurs. Typically, comments are temporally displayed, that is, they are visible in the order in which they were entered. For example, a comment entered by a user on July 5^{th} will be displayed before a comment entered by a user on August 12^{th} of the same year. This approach, however, can make it difficult for a viewer to find comments related to a specific point or segment of a video (or other content) and to comment on the like. Modern web-based interfaces for comments, therefore, can provide a disconnected experience with respect to comments and content such as video. It would be desirable to provide a system that manages and displays comments that are relevant to particular portions of content in a more useful way.

### BRIEF SUMMARY

According to an embodiment of the disclosed subject matter, a method of providing comments for display at a time reference during a video may include providing the video and an associated comment feed to a user. The comment feed includes comments and each of the comments may be provided at a display time. Comment information may be received from the user, the comment information including a comment submitted by the user and a time reference indicating a point in time during the video the comment was submitted by the user. An availability of the time reference for the comment may be determined and the display time for the comment may be established. The comment feed may be updated to provide the comment submitted by the user at the determined display time of the video.

In an embodiment, a comment feed and a video (or other content such as audio, video, or multimedia) may be provided, for example, by a content server. The comment feed and the content may be provided by separate servers. A submitted comment may be received with a submitted reference that corresponds to at least one point (i.e., may be a range of points) in the video (or other content). For example, a reference may include a time reference, a frame reference, or an event occurring in the content. It may be determined that an existing comment is not displayed in the comment feed at the submitted reference during the video (or other content). The submitted comment may be added to the comment feed to be displayed at the submitted reference. Further, the comment feed may be provided to one or more users (e.g., updated in real time).

In an embodiment, a comment feed and a video (or other content such as audio, video, or multimedia) may be provided, for example, by a content server. The comment feed and the content may be provided by separate servers. A submitted comment may be received with a submitted reference that corresponds to at least one point (i.e., may be a range of points) in the video (or other content). For example, a reference may include a time reference, a frame reference, or an event occurring in the content. It may be determined that an existing comment is displayed in the comment feed at the submitted reference during the video (or other content). A proximate reference to the submitted reference at which an existing comment is not displayed may be determined. The submitted comment may be added to the comment feed to be displayed at the proximate reference. Further, the comment feed may be provided to one or more users (e.g., updated in real-time).

According to an embodiment of the disclosed subject matter, a comment feed and a video (or other content such as audio, video, or multimedia) may be provided, for example, by a content server. The comment feed and the content may be provided by separate servers. A submitted comment may be received with a reference that corresponds to at least one point (i.e., may be a range of points) in the video (or other content). A reference may include a time point, a video frame, and an event occurring in the video. A duration for the submitted comment may be determined. An available slot for the comment may be determined. The available slot may include a range of reference points that includes the submitted reference and does not include any reference point at which an existing comment is displayed in the comment feed. The submitted comment may be added to the comment feed to be displayed in the available slot. Further, the comment feed may be provided to one or more users (e.g., updated in real-time).

In an embodiment, a comment feed and a video (or other content such as audio, video, or multimedia) may be provided, for example, by a content server. The comment feed and the content may be provided by separate servers. A submitted comment may be received with a reference that corresponds to at least one point (i.e., may be a range of points) in the video (or other content). A reference may include a time point, a video frame, and an event occurring in the video. A duration for the submitted comment may be determined. A nearby slot for the comment may be determined. The nearby slot may include a range of reference points that does not include the submitted reference, does not include any reference point at which an existing comment is displayed in the comment feed, and includes the reference point that is closest to the submitted reference point and at which no existing comment is displayed in the comment feed. The submitted comment may be added to the comment feed to be displayed in the nearby slot. The updated comment feed may be provided upon subsequent viewing by another (including, possibly, the user) of the reference point (i.e., nearby the submitted reference point).

In one or more embodiments, a social network associated with a comment source may be determined. The comment source may, for example, be a user. A social network may include a social networking site or a forum. The comment feed may be filtered according to the social network. For example, the comment feed may display comments from those individuals who belong to the social network of the user who initiated playback of the content. Further, an available slot may be determined based on the filtered comment feed.

The comment feed may be adapted, filtered, and adjusted both on the fly, in response to specified factors, prior to comment submission, or while determining an available slot. For example, multiple comments may exist at the reference. Each comment may occupy a slot for the reference. For example, a comment feed may allow three comments to be visible at any specific reference point (i.e., there are three slots available for every reference on the comment feed). Once more than three comments have been submitted that overlap the specific reference point, the comment feed may, for example, scroll the first three comments to display the fourth comment if the first of the three comments has passed a determined minimum display length.

An available slot may be determined in a variety of ways and, in some configurations, it may have a threshold number of comments per reference point. For example, an available slot may exist where the number of comments is below the threshold number at the reference point. The determination of an available slot may thus be based on the number of comments at the reference point (e.g., whether the number of comments below a threshold number). The comment feed may be filtered according to one or more filtering criteria. Filtering criteria may include, for example, a rating, a popularity, a user-defined selection, a seniority, and a social network. A slot may be deemed available after filtering according to the social network of a user.

Various embodiments of the disclosed subject matter can alter a comment feed based on at least one type of a submitted comment and at least one type of an existing comment in the feed. Examples of a comment type include the author of the content. The author can be the actual or purported author, e.g., the actual person who writes and/or submits the comment or a character in a video that is identified as the author of the comment, even though the actual such comment may be authored by a cast member or by a script writer. The comment type can also be based on the content of the comment. For example, the type can be based on the format of the comment (video, audio, text, etc.), the meaning of the comment (e.g., an alert, a advertisement, the occurrence of certain keywords and/or fragments and/or sentences in the comment), etc.) A type can also be based on the source of a comment, e.g., by network address, by source system name, device identifier, etc. A type can also be based on the object of the comment, e.g., a particular event, character, product, etc.

A user can submit a submitted comment for display in the comment feed at a submitted reference point. The comment feed can already be populated with one or more existing comments. A comparison can be made between one or more types of the submitted comment and one or more types of an existing comment that is displayed at the submitted reference in the comment feed to obtain a comparison result. For example, the author of the submitted comment can be compared to the author of the existing comment. The author of the submitted comment could be a cast member or the submitted comment could be authored by a scriptwriter of the video to purport to be from a character in the video being commented upon. If the existing comment is authored by an ordinary viewer, then the submitted comment can be determined to take priority over the existing comment, based on the comparison result. In that case, the existing comment can be moved, deleted or otherwise modified so that the submitted comment can occupy at least a part of the comment feed formerly (before the modification) occupied by the existing comment.

In various embodiments, the comparison result may be based upon a combination of types of comments. Thus, for example, a submitted comment that is an alert and has the keyword “Urgent” can be determined to take priority over an existing comment authored by a character unless the character comment includes the keyword “product.” Any combination of one or more submitted and existing comment types can be used as the basis for establishing the priority of a submitted comment in relation to an existing comment.

According to an embodiment, a system is disclosed that may include a database for storing video (or other content such as audio or multimedia) and a comment feed. The system may have multiple databases. For example, one database may store or provide the content (e.g., video, audio, or multimedia) and another database may store or provide the comment feed. The comment feed may comprise a variety of data types (e.g., video, audio, image, multimedia, and text). As used herein, a database can be, for example, a relational database, a non-relational database, a distributed database, a flatfile, or any device or system capable of storing information that can be read by a computer. A processor may be connected to the database and be configured to provide the video (or other content) and the comment feed. The processor, for example, may belong to a server. It may receive a submitted comment with a submitted reference that corresponds to at least one point in the video. The processor may determine that an existing comment is not displayed in the comment feed at the submitted reference during the video (or other content). It may add the submitted comment to the comment feed to be displayed at the submitted reference. The system may provide the updated comment feed that includes the submitted comment.

In an embodiment, a system is disclosed that may include a database for storing video (or other content such as audio or multimedia) and a comment feed. The system may have multiple databases. For example, one database may store or provide the content (e.g., video, audio, or multimedia) and another database may store or provide the comment feed. The comment feed may comprise a variety of data types (e.g., video, audio, image, multimedia, and text). A processor may be connected to the database and be configured to provide the video (or other content) and the comment feed. The processor, for example, may belong to a server. It may receive a submitted comment with a submitted reference that corresponds to at least one point in the video. The processor may be configured to determine that an existing comment is displayed in the comment feed at the submitted reference during the video and to determine a proximate reference to the submitted reference at which an existing comment is not displayed. The processor may add the submitted comment to the comment feed to be displayed at the proximate reference. The system may provide the updated comment feed that includes the submitted comment.

In an embodiment, a system is disclosed that may include a database for storing video (or other content such as audio or multimedia) and a comment feed. The system may have multiple databases. For example, one database may store or provide the content (e.g., video, audio, or multimedia) and another database may store or provide the comment feed. The comment feed may comprise a variety of data types (e.g., video, audio, image, multimedia, and text). A processor may be connected to the database and be configured to provide the video (or other content) and the comment feed. The processor, for example, may belong to a server. It may receive a submitted comment with a submitted reference that corresponds to at least one point in the video. It may determine a duration for the submitted comment. The processor may determine an available slot for the comment. The available slot may include a range of reference points that includes the submitted reference and does not include any reference point at which an existing comment is displayed in the comment feed. The processor may add the submitted comment to the comment feed to be displayed in the available slot. The system may provide the updated comment feed that includes the submitted comment.

According to an embodiment, a system is disclosed that may include a database for storing video (or other content such as audio or multimedia) and a comment feed. The system may have multiple databases. For example, one database may store or provide the content (e.g., video, audio, or multimedia) and another database may store or provide the comment feed. The comment feed may comprise a variety of data types (e.g., video, audio, image, multimedia, and text). A processor may be connected to the database and be configured to provide the video (or other content) and the comment feed. The processor, for example, may belong to a server. It may receive a submitted comment with a submitted reference that corresponds to at least one point in the video. It may determine a duration for the submitted comment. The processor may be configured to determine a nearby slot for the comment. The nearby slot may include a range of reference points that does not include the submitted reference, does not include any reference point at which an existing comment is displayed in the comment feed and includes the reference point that is closest to the submitted reference point and at which no existing comment is displayed in the comment feed. The processor may add the submitted comment to the comment feed to be displayed in the nearby slot. The system may provide the updated comment feed that includes the submitted comment.

Additional features, advantages, and embodiments of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1A shows an example system configuration according to an embodiment of the disclosed subject matter. FIG. 1B is an example of a computer arrangement according to an embodiment of the disclosed subject matter.

FIG. 2 shows an example flowchart including determining the availability of a time reference according to an embodiment of the disclosed subject matter.

FIG. 3 is an example user interface displaying a comment feed according to an embodiment of the disclosed subject matter.

FIG. 4 shows a user interface where a comment has been entered for submission according to an embodiment of the disclosed subject matter.

FIG. 5 show a user interface with an updated comment feed displaying the comment submitted in FIG. 4.

FIG. 6 shows an example user network according to an embodiment of the disclosed subject matter.

FIG. 7 shows an example flowchart including determining a comment type according to an embodiment of the disclosed subject matter.

FIG. 8 shows a user interface for entering a scripted comment according to an embodiment of the disclosed subject matter.

FIG. 9 shows the user interface of FIG. 3 showing a scripted comment according to an embodiment of the disclosed subject matter.

FIG. 10 shows an example flowchart including filtering a comment feed according to an embodiment of the disclosed subject matter.

### DETAILED DESCRIPTION

In various implementations, a viewer's experience of an interactive video (or other content such as audio or multimedia) may be enhanced with an improved manner of displaying comments in a comment feed. The comment feed may be displayed in conjunction with a video (or other content) that a user is viewing or playing. The comments may be organized in a manner that associates a comment with a reference point or points in the video (or other content). A reference may include without limitation a time in the video, a frame number, or a combination thereof (e.g., a SMPTE code). For example, a user may enter a website (optionally one in which the user has subscribed to or created a user profile) and initiate playback of content. While the content is being provided by the website, the user may desire to submit a comment on a particular part of, for example, a scene of a video. The user may enter and submit a comment while watching the scene. Submission of the comment may associate with the comment a reference, which may correspond to the part of the video during which the comment was submitted. The reference may be stored on a server or the like and a comment feed may display the submitted comment at the reference point. The comment feed may be updated in real-time with the comment such that subsequent viewings of the scene may cause the comment to be visible to another user. In some instances, the comment submission reference may already have a comment and the already existing comment may preclude the user's submitted comment from occupying the reference point. However, according to embodiments disclosed herein, a proximate location, which may be a site that is proximal to the reference point of the submission, may be determined and the comment may be provided therein. A reference can refer to a point or a range of points in the video. The number of comments that are displayed at a given point during the video may be limited to a number that is manageable to read by a viewer.

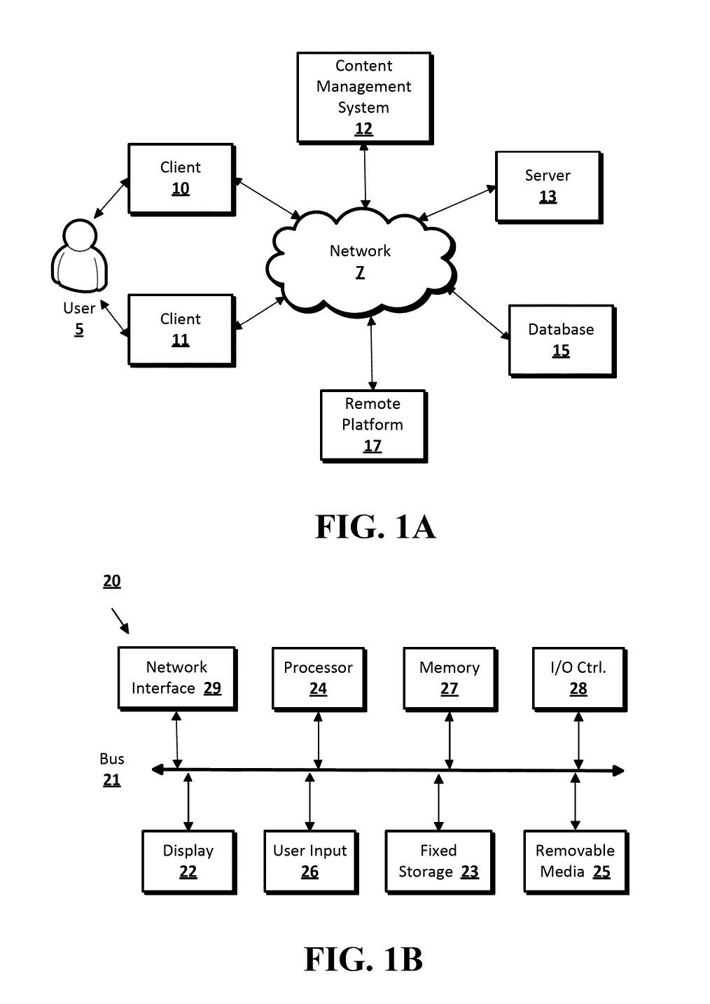

FIG. 1A shows an example system arrangement according to an embodiment of the disclosed subject matter. Shown is a content management system 12, one or more servers 12, including web servers, one or more databases 15, a remote platform 17, and one or more clients 10, 11 associated with one or more users 5, and a communication network 7.

The content management system 12 can include a processor, a main memory, a storage, including video and comment data, and software for executing instructions. This software includes software capable of operating the content management system consistent with the subject matter explained herein. The content management system operates to store and deliver video on demand or in real-time along with an associated comment feed.

One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. Users 5 may use the clients to communicate with the content management system 12, or servers 13 and/or databases 15. The devices may be directly accessible by the clients 10, 11, or one or more other devices may provide intermediary access such as where a server 13 acts as a web server, or provides access to resources stored in a database 15.

Server 13 can operate to serve web pages at the demand of a client 10, 11. In other embodiments, the server 13 may not be present (e.g. for a smart phone that shows the video player and comment stream player without a surrounding web page, or with a specialized application (“App”) installed on the smart phone).

The clients 10, 11 also may access remote platforms 17 or services provided by remote platforms 17 such as cloud computing arrangements and services. The remote platform 17 may include one or more servers 13 and/or databases 15, which may store video and comment data.

Although the content management system 12, server 13, database 15, and remote platform 17 are shown in FIG. 1A as separate devices, there is no requirement that they are separate devices. In other embodiments, the content management system 12, server 13, and database 15 can be combined in some combination, including over the remote platform 17. For example, the content management system 12, server 13, and database 15 can be combined such that a video and comment data reside on a combination of the devices.

Embodiments of the presently disclosed subject matter may be implemented in and used with a variety of component and network architectures. FIG. 1B is an example computer 20 suitable for implementing embodiments of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 1A.

Many other devices or components (not shown) may be connected in a similar manner (e.g., document scanners, digital cameras and so on). Conversely, all of the components shown in FIG. 1B need not be present to practice the present disclosure. The components can be interconnected in different ways from that shown. The operation of a computer such as that shown in FIG. 1B is readily known in the art and is not discussed in detail in this application. Code to implement the present disclosure can be stored in computer-readable storage media such as one or more of the memory 27, fixed storage 23, removable media 25, or on a remote storage location.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

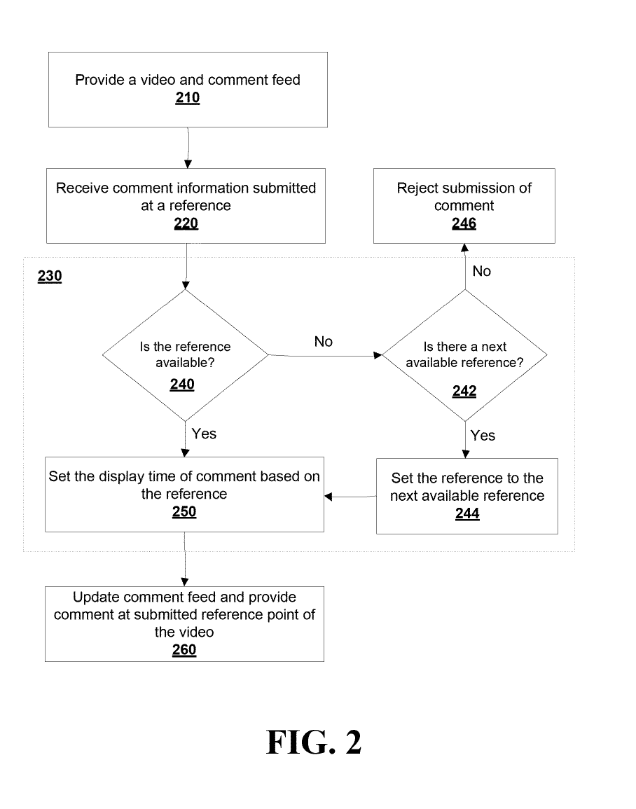

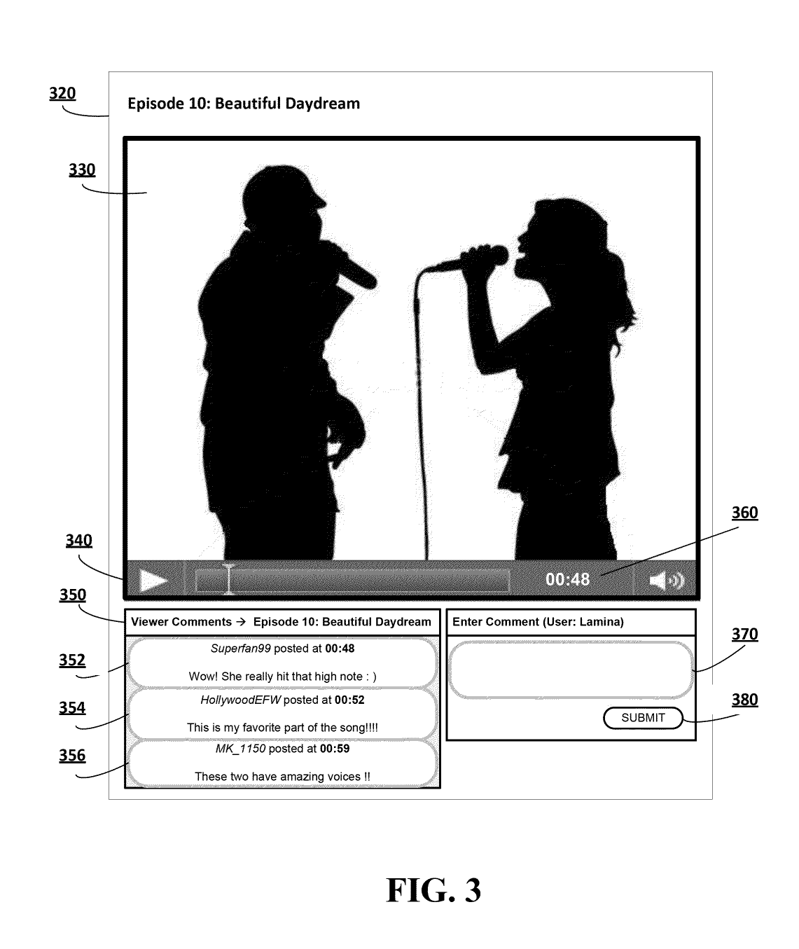

FIG. 2 shows a flowchart of a method for providing a video and associated comment feed according to one embodiment. The method may be performed, for example, by the system shown in FIG. 1. At step 210, the content management system 12, for example, may provide a video (or other content) and comment feed to a user computer (i.e., user 5). The comment feed may be associated with the video (as shown in FIG. 3) or it may be provided as a separate browser window or dissociated from the content (i.e., video). Content may be provided in the form of a downloaded file, a content stream, or on stored media, etc. For example, a user 5 at a client 10, 11 may use a web browser to access the content (e.g., video). The web browser may request the video and associated comment feed from the content management system 12. The comment feed may be provided from a separate server 13 from the content management system 12. For example, the web browser may provide content, the comment feed, or both content and the comment feed using JavaScript, DHTML, or the like.

At 220, when a user submits at comment, the content management system 12, for example, may receive comment information that includes the comment and a reference indicating the point during the video (or other content) that the comment was entered. The comment may include text, as well as other forms of data including graphics, links and even audio and video content of its own. The reference may include a timecode, a frame number, a SMPTE timecode, or any other customized method known to a person of ordinary skill to accurately record a point of the video (or other content) when the comment was submitted by the user. In various embodiments, the reference may include a range or a set of several such points in the video. The reference may be a relative point in the video (e.g., time since the start of the video, number of frames into the video, etc.) or an absolute time (e.g., date and actual time of entry), which may be useful for managing comments on live video events that are being streamed, for example.

The reference of a comment may be determined in different ways. For example, the submission of a comment may cause the comment to be stamped for a relative time, an absolute time, a frame number, or other event transpiring during the playback of the content. A server 13 may store the stamp in a database, in local fixed storage, or in memory in some cases. A relative time of submission may be based upon the time at which an indication was received that a user would like to enter a comment. For example, in some configurations, a user may need to select a button indicating to the website (i.e., server) that the user would like to comment. The absolute time may refer to the time at which the comment is received by the web server. It may also be the time at which the comment is submitted (typically, in low latency systems, the comment submission and receipt of the comment by a server are nearly identical). The frame reference may refer to a multimedia or video content. Video is typically composed of a series of frames. An indication of the user making a comment may be received and stamped at a particular frame of the content. The submit reference point may also be based on the point at which the user starts entering text into the comment field, or in combination with the submit point. This may be beneficial in circumstances where the user enters a lengthy comment or does not type fast. Likewise, a series of references may be recorded based on the point at which the user begins entering the comment and the point that the user “submits” the comment. This series of references or range can be used to more accurately and relevantly place the comment in the comment feed and to produce a more useful arrangement of the comments in the comment feed overall. Such processing can include calculating the mean reference point by adding the beginning and the ending points and dividing by two, calculating statistical parameters such as means and variances based upon the points at which keystrokes can be recorded to find statistical parameters such as means, variances, deviations, etc. These calculated parameters can be used to best place the comment in the comment feed.

At 230, a reference (e.g., reference point) of the comment submitted by the user may be determined. This determination, for example, may include verifying whether the reference of the submitted comment is available at 240. The availability of the reference may be determined using various methods. For example, the availability may be based on whether a comment already exists in the comment feed and is displayed at a time corresponding to a time reference. In an embodiment, the comment feed may only display one comment for a given display period. In other embodiments, the comment feed may display multiple comments for a given display period, in which case the comments share the display time. The number of comments displayed by the comment feed may be predetermined. In addition, the number of comments displayed at a given time may be based on the comment feed window size. For example, if the comment feed window may display up to three comments simultaneously, the number of comments for a given time will be limited to three.

The availability of the time reference may also be determined based on preset availability times. For example, an administrator may establish a time or frame number for which a comment may not be submitted (e.g., commenting may be deactivated or rejected). Similarly, an administrator may determine that a particular display time be limited to, for example, an advertisement or for other content, or for comments from a particular user. Thus, the comment feed may be modified or adapted for specific uses beyond user comments.

The availability of a reference may be determined based upon a variety of factors. For example, a display duration for an existing (e.g., already submitted) comment and a presently submitted comment may be used to determine the availability of a particular slot. Typically, a viewer requires a minimum duration to be able to read a comment. The time required for a user to read a comment is also dependent on the length of a comment. In some systems, comment length may be regulated (e.g., of a fixed length). Similarly, an amount of time may be defined in order to improve the readability of the comments. In an embodiment, a duration of three seconds may be associated with a reference (e.g., time) of a submitted comment to ensure that a comment may be visible and comprehended by most users. The duration can be expressed in any suitable way and is not limited to a time measurement (e.g., duration may be determined by the number of frames or by the number of bits streamed). The duration may be dynamic, and may be based on a function of the number of submitted comments (e.g. the duration can decrease as the number of submitted comments increases). Accordingly, the availability function may need to determine not only the availability of the reference, but also the duration that a comment may be displayed by the comment feed.

At 240, if the reference of the submitted comment is not available, an availability of another reference may be determined at 242. For example, if a particular display reference is not available, the comment may be allotted the next available display reference. The next available display time may be immediately after or before the requested display reference, or may be at another point in the video. For example, a calculation may be performed by the server (or, for example, a comment database) to determine the most proximate position to the submitted reference for the comment. The calculation may be based on comparing the start point, end point, or both the start and end points of the submitted reference to those of comments already existing in the comment feed. The system may be configured to obey specific rules. For example, it may be biased to favor placing comments after the submission reference to prevent a comment from disclosing a future event prematurely.

The next available display reference determination may also include a specified relevancy span of display points for a given comment. A relevancy span may be a duration (e.g., 3 seconds, 90 frames, 3 Mb) within which a comment is likely to be relevant to events being shown in the video (or other content). For example, the system may know (e.g., using metadata associated with the video) the beginning and end points of a scene or movement (e.g., Scene 3 starts at frame 1450 and ends at frame 2390). A comment submitted by a user during the Scene 3 relevancy span may be shown at the point it was submitted during Scene 3. If that point is not available, it may be shown at a nearby point only if that nearby point is also within the Scene 3 relevancy span. Otherwise, it may not be shown at all. A relevancy span may be defined in any suitable way to designate a point or points (e.g., reference) in the content (e.g., video) associated with one or more events. For example, a relevancy span may include the point or a range of points in the video at which a character in the video first appears, picks up a product, or falls down.

If a next available reference is determined to be available at 242, the reference at which the comment is to be displayed may be set to the next available reference at 244. If a next available reference is not available, then the user may be informed at 246 that the reference is not available. For example, a user's comment may be rejected. In some configurations, the system may indicate that certain display references are not available for comments prior to a user submitting a comment. For example, the comment entry field may be disabled or deactivated during references (e.g., time ranges, frame ranges, etc.) of the video that are not available for comment submissions. The system may also present the user with alternative display references that the user may select.

If a reference is available at 240, or a next available reference is set at 242 and 244, the display reference of the submitted comment may be determined based on the determined available reference at 250. As described above, the display reference may be set to the a given single reference or a duration based on reference points in the video (or other content) determined to be available and a predefined or determined minimum, maximum, or exact display duration for the comment.

At 260, the comment feed may be updated in real-time to include the submitted comment. The comment feed may provide the comment for display at the determined display time. In other embodiments, the comment feed may be updated at a later point, such as when another user views the video (or other content) along with its comment feed.

Although the method shown in FIG. 2 is described serially, the steps or operations can be performed by separate elements in conjunction or in parallel. There is no particular requirement that the method be performed in the same order in which this description lists the steps, except where indicated. FIG. 2 is illustrative of one potential configuration of the comment feed and video as described herein.

FIG. 3 shows an example user interface displaying a comment feed according to an embodiment of the disclosed subject matter. The user interface 320 includes a video 330 and video controls 340. The video controls 340 also include a time counter 360 indicating a point in time during the video. The user interface 320 also includes a comment feed window 350, which includes a comment feed that comprises, for example, comments 352, 354, and 356. In addition, the user interface 320 also includes a comment entry field 370 and submission controls, for example, a submit button 380.

As shown in FIG. 3, the comment feed window 350 can display comments based on a particular reference or range of references of the video. In the example shown, comment 352 was submitted at a time reference of 00:48 during the video, and thus, appears on the top of the window at time 00:48 of the video. The next comment in the comment feed is comment 354, which has a submit time of 00:52. Accordingly, when the video reaches a time reference of 00:52, comment 354 will be displayed on the top of the window. In the example shown, the comment feed display window 350, displays three comments at a time in the comment feed, but this may be altered to display one comment at a time, or any number of comments. In addition, the comment feed window 350 may have different layouts and orientations, including a horizontal or vertical arrangement of comments. The comment feed window 350 may also animate or scroll comments during updates or transitions.

In an embodiment, the comment feed window 350 may display comments in a threaded layout wherein a portion of the window is expanded (or a second window is opened) when a comment is selected to display additional related comments (e.g. by time or topic) or replies. Additional comments may be viewed using a second comment window. A second comment feed window may be displayed when a user selects a particular comment or performs another action (e.g. clicks on an expand button). The second comment feed window may be displayed within the user interface 320 or may be a separate window (e.g. pop-up).

The user interface 320 may also include a comment entry portion, such as a comment entry field 370 and a submission method, such as a submit button 380. A user may enter, for example, text into the comment entry field 370 at a given point during the video and click the submit button to submit the comment.

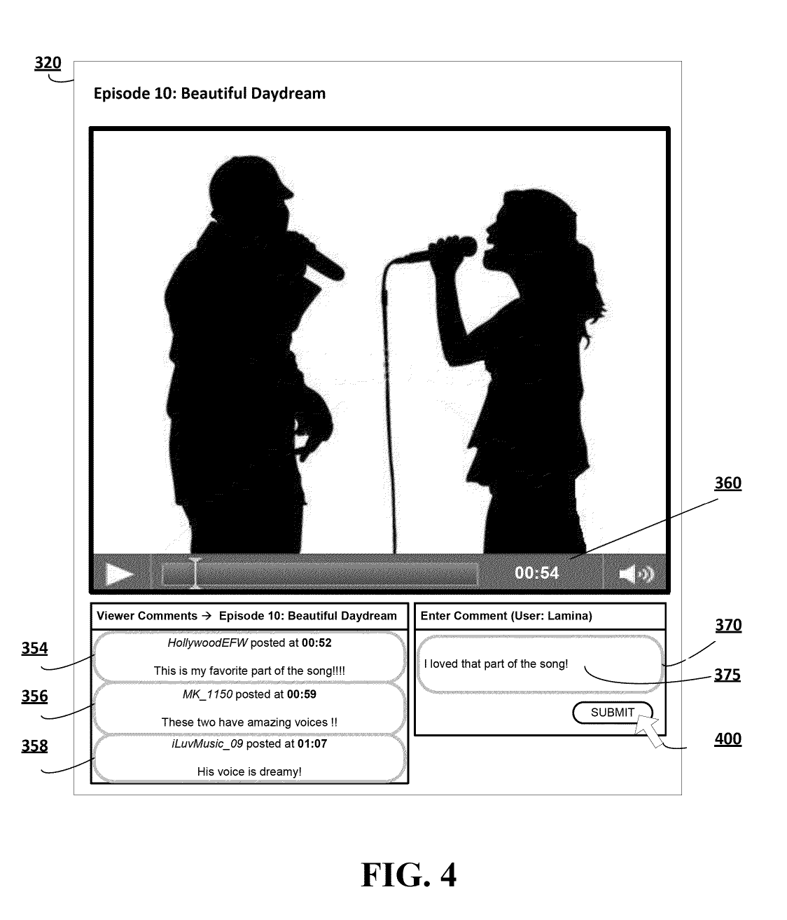

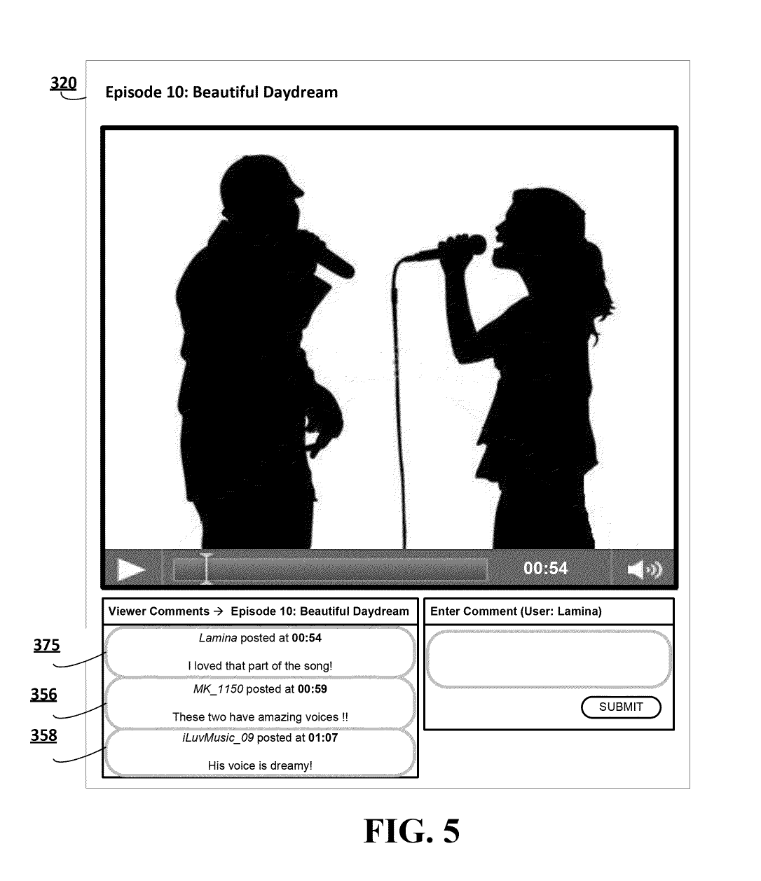

FIG. 4 shows an example of a user entering a comment for submission. As shown, the time counter 360 has elapsed to 00:54 seconds into the video. Accordingly, comment 354 is now displayed at the top of the comment feed window 350. Correspondingly, comment 356 has now moved up one spot in the comment feed window, and another comment 358 has taken the previous position of comment 356. In the example shown in FIG. 4, a comment corresponding to the reference point of the video is displayed in a top position of the comment feed window 350. Other methods of distinguishing comments corresponding to the current reference point of the video may also be used (e.g. highlighting, or other form of animation). As shown in the example of FIG. 4, a user 5 may enter a comment 375 in to the comment entry field 370. When the user 5 clicks the submit button 380 with, in this example, a cursor 400, the reference point (in this case 00:54 seconds) is stored and the comment feed is updated, for example as shown in FIG. 5.

FIG. 5 shows an example of an updated comment feed displaying the comment submitted in the example of FIG. 4. As shown, the comment feed may update in real-time and the comment 375 submitted in FIG. 4 in now displayed in a top position of the comment feed window 350. Comments 356 and 358, for example, remain in their respective positions because their respective reference points have not yet been reached in the video.

In addition, the user interface 320 may include additional buttons and options when submitting a comment. For example, the user may elect whether the comment should update the comment feed scrolling from the top or the bottom, as well as a tick up or tick down position. The comment submission window may be also be hidden when not in use and may, for example, have a compact mode. A full-mode may appear upon an action, for example, an expand selection, or a hover over a particular portion of the user interface 320.

In an embodiment, a comment feed and a content (e.g., video audio, or multimedia) may be provided, for example, by a content server. The comment feed and the content may be provided by separate servers. A submitted comment may be received with a submitted reference that corresponds to at least one point in the video (or other content). For example, a reference may include a time reference, a frame reference, or an event occurring in the content. It may be determined that an existing comment is not displayed in the comment feed at the submitted reference during the video (or other content). The submitted comment may be added to the comment feed to be displayed at the submitted reference. Further, the comment feed may be provided to one or more users (e.g., updated in real time).

In an embodiment, a comment feed and a content (e.g., video, audio, or multimedia) may be provided, for example, by a content server. The comment feed and the content may be provided by separate servers. A submitted comment may be received with a submitted reference that corresponds to at least one point in the video (or other content). For example, a reference may include a time reference, a frame reference, or an event occurring in the content. It may be determined that an existing comment is displayed in the comment feed at the submitted reference during the video (or other content). A proximate reference to the submitted reference at which an existing comment is not displayed may be determined. The submitted comment may be added to the comment feed to be displayed at the proximate reference. Further, the comment feed may be provided to one or more users (e.g., updated in real time).

According to an embodiment of the disclosed subject matter, a comment feed and content (e.g., video, audio, or multimedia) may be provided, for example, by a content server. The comment feed and the content may be provided by separate servers. A submitted comment may be received with a reference that corresponds to at least one point in the video (or other content). A reference may include a time point, a video frame, and an event occurring in the video. A duration for the submitted comment may be determined. An available slot for the comment may be determined. The available slot may include a range of reference points that includes the submitted reference and does not include any reference point at which an existing comment is displayed in the comment feed. The submitted comment may be added to the comment feed to be displayed in the available slot. Further, the comment feed may be provided to one or more users (e.g., updated in real time).

In an embodiment, a comment feed and a content (e.g., video, audio, or multimedia) may be provided, for example, by a content server. The comment feed and the content may be provided by separate servers. A submitted comment may be received with a reference that corresponds to at least one point in the video (or other content). A reference may include a time point, a video frame, and an event occurring in the video. A duration for the submitted comment may be determined. A nearby slot for the comment may be determined. The nearby slot may include a range of reference points that does not include the submitted reference, does not include any reference point at which an existing comment is displayed in the comment feed, and includes the reference point that is closest to the submitted reference point and at which no existing comment is displayed in the comment feed. The submitted comment may be added to the comment feed to be displayed in the nearby slot. The updated comment feed may be provided upon subsequent viewing by another (including, possibly, the user) of the reference point (i.e., nearby the submitted reference point).

In some systems, a large number of comments may be submitted with a particular content and may, therefore, require additional techniques for determining relevancy. Along with managing comments based on a submitted reference point of the video, comments may be managed based on one or more filtering criteria. A comment type may be based on various characteristics, including, for example, how the comment was submitted or based on the user that submitted the comment. Filtering criteria may be based on, for example, profile information. Accordingly, information regarding particular users, user type, and relationships may be beneficial in managing comments.

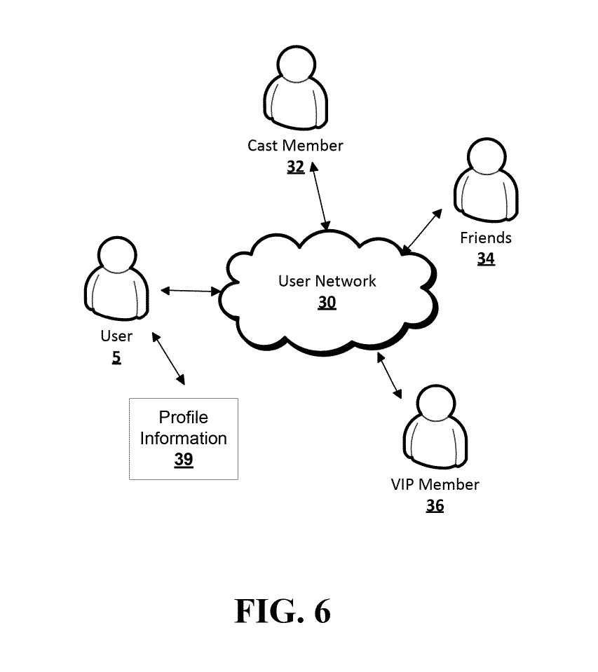

FIG. 6 shows various relationships a user may have in the user network 30. For example, the user network 30 may include one or more cast members 32, friends 34, and VIP members 36. The user 5 may be associated with these users and these relationships may be stored in the user profile information 39 associated to the user. The user 5 may also be associated to a member type which may affect the manner in which the user's comments will be managed (e.g., priority order). The member type may also be used to determine a comment type as described hereafter.

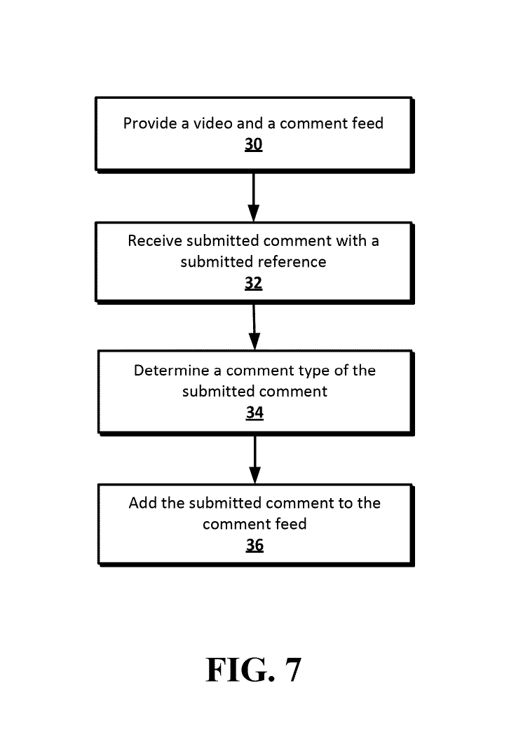

FIG. 7 shows an example of determining a comment type according to an embodiment of the disclosed subject matter. At step 30, the content management system 12, for example, may provide a video (or other content) and comment feed to a user computer (i.e., user 5) as described herein. At 32, the content management system 12, for example, may receive comment information that includes the comment and a reference indicating the point during the video (or other content) that the comment is to be displayed. The comment may include text, as well as other forms of data including graphics, links and even audio and video content of its own. The reference may include a timecode, a frame number, a SMPTE timecode, or any other customized method known to a person of ordinary skill to accurately record a point of the video (or other content).

The comment and reference may be received in several ways at 32. The comment and reference may be received from a user through, for example, the user interface 320 while a user is viewing the video (or other content). In addition, a comment and reference may be received in a manner as if it were submitted by a user. An automated may also be employed to receive the comments. For example, if an administrator requires a comment to be submitted during a video at a predefined reference, it may be beneficial to automate such a process. This may be beneficial, for example, when the comment originates from a cast member of the video, and is scripted to appear at a predefined time during a video.

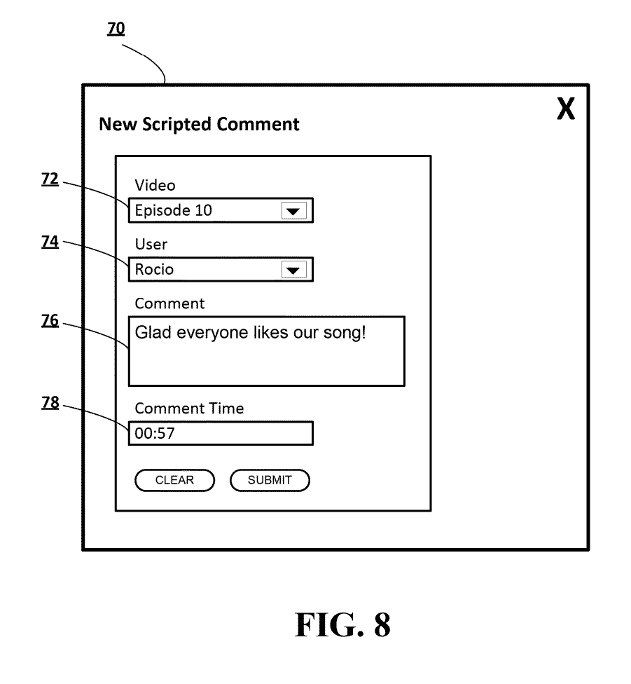

FIG. 8 shows a user interface for entering a scripted comment according to an embodiment of the disclosed subject matter. A scripted comment may be a comment that is to be displayed at a predefined time. The interface 70 may be used by administrators or other users with enhanced privileges (e.g., cast members). The interface 70 may also be used based on predefined settings or to all users. The interface 70 may include a content selection field 72 (e.g., episode selection for videos), a user selection field 74, a comment field 76 and a comment reference 78 (e.g., a time reference in the video). The fields may be displayed in a drop down menu or other entry types. The user selection field 74 may designate the comment source, even though that user may not be the user actually entering the comment into the interface 70. In the example of FIG. 8, an administrator (or any other privileged user including Rocio) may enter information and the comment feed may display a comment appearing to be from Rocio (e.g. cast member) at 00:57 seconds into the episode 10 video as shown in FIG. 8.

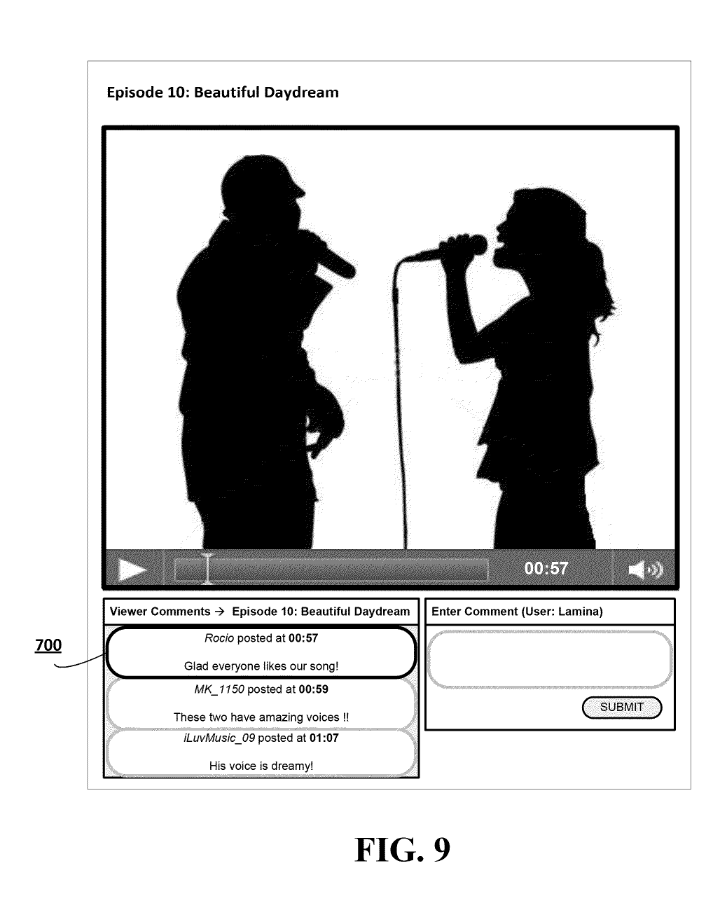

FIG. 9 shows a user interface showing a scripted comment according to an embodiment of the disclosed subject matter. Comment 700 submitted by Rocio as entered in the interface 70 of FIG. 8 may be displayed at the top-most position of the window in a prioritized manner. The comment may be highlighted to indicate the comment is from a cast member. The comment may have an adjusted (e.g., extended) display duration and other comments may continue to update below Rocio's comment as it retains its top-most position.

Returning to FIG. 7, the display characteristics (e.g., prioritized display) may be determined based on the determined comment type at 34. The comment type may, for example, be based on the interface as shown in FIG. 8, or may be based on other factors. The other factors may include, for example, the user type that submitted the comment, the time and/or reference of the submitted comment. The user type may relate to, for example, whether the user is a cast member (e.g., Rocio), administrator, moderator, or VIP user. A VIP user may, for example, be a user that has paid a subscription or membership fee, and therefore, benefits from enhanced privileges. User profile information (described below), or social networking characteristics may also be used to determine a comment type. For example, a comment submitted by a VIP user using the user interface 320 as shown in FIG. 4, may have a prioritized display as shown in the example of FIG. 9.

Based on the comment type, the comment may be prioritized over other existing comments or subsequent comments. For example, the comment may be exclusively displayed at a given reference point of, for example, a video (or other content). Prioritization may include special display characteristics that distinguish the comment over other comments. For example, the comment may be highlighted, animated, accompanied by an alert (e.g. pop-up, sound, or the like), or may be positioned in preferential manner. For example, if multiple comments are displayed at a reference point, a prioritized comment may maintain a top-most position. Moreover, the prioritized comment may have a greater display duration than other comments or maintain a top-most position when there are multiple comments. Accordingly, other comments may continue to be updated below the prioritized comment. A priority order for multiple comments sharing a given reference may also be determined.

The comment type may also determine other characteristics of the comment. For example, comments with a particular comment type may replace comments at a given time reference that do not share that particular comment type. Certain comment types may also maintain exclusivity over particular reference points of a video (or other content).

Another method of managing the comments submitted to a content includes filtering comments. Comments can be filtered based on comment type or on other criteria including profile information and social network information.

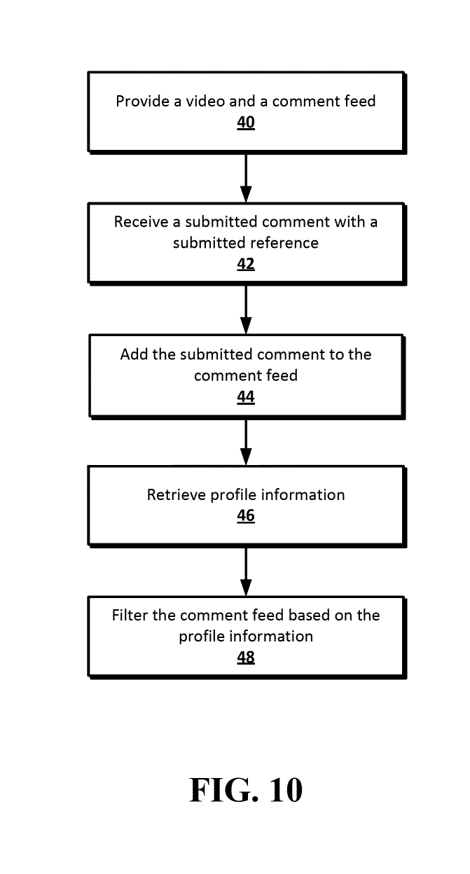

FIG. 10 shows an example of filtering a comment feed according to an embodiment of the disclosed subject matter. At step 40, the content management system 12, for example, may provide a video (or other content) and comment feed to a user computer (i.e., user 5) as described herein. At 42, the content management system 12, for example, may receive comment information that includes the comment and a reference indicating the point during the video (or other content) that the comment is to be displayed. The comment may include text, as well as other forms of data including graphics, links, audio, and video. The reference may include a timecode, a frame number, a SMPTE timecode, or any other customized method known to a person of ordinary skill to accurately record a point of the video (or other content). The comment may receive comment information using any of the methods described herein. At 44, the submitted comment is added to a comment feed. The method of determining a reference may be based on any of the methods described herein.

Profile information 39 from a user may be retrieved at 46. For example, a user may subscribe or create a user name and password to access a website. The website may contain content with which the user would like to interact and, in order to do so, the user may be required to subscribe to the website (e.g., creating an account or registering with the website). In addition to a username and password, user profile information may also include, for example, a birthdate, an image such as a profile image, a mobile phone number, an email address, a social network user identifier, a gender, a video content, an audio content, a location, language and a country. Other information may also be entered into a user profile and constitute profile information 39. For example, a user may indicate a desired level of participation in social networking with content provided on the website, such as whether or not the user would be interested in receiving offers to connect to the social networking system of one of the cast members of a video (e.g., another user), or an entity associated with a video or other content (e.g., a production company, producer, or a program series to which the video belongs). A user may elect to participate in certain offerings provided by a particular multimedia content (e.g., connecting with cast members but not a program series or business). User profile information may indicate whether or not the user is interested in receiving on-screen alerts. The user profile information 39 may also include preferences for receiving comments, such as comments from only those members with highly rated comments, cast members, or members that share demographic information with the user. The profile information 39 may also include social networking information including users that the second user considers friends.

User profile information 39 may also include items not physically entered by a user or system administrator; rather, it may include information that is collected based upon the first user's activity on a website on which the content (e.g., video) is located (i.e., including the parent site and any related pages or sites). For example, a user viewing videos of a particular cast member or other information about the cast member may be targeted to have an invitation to connect to that cast member's social networking system relative to another user who has never viewed content containing the same cast member. The user profile information 39 may be maintained, for example, by the content management system 12 or a database connected to a server and the user's computer (e.g., client) via a network.

In addition, the profile information 39, may include user network information relating to a social networking system. The social networking system may include a social networking site and its associated content (including the network of users or an internet forum). A social networking site may permit users, once registered, to connect with other acquaintances or friends. Typically, a user is provided recommendations of individuals and/or other entities with whom the user may like to associate (or know) based on a user profile or people with whom the user has already associate with on the website. A user may request, reject, accept, or ignore a friend invitation with other users of the social networking site. In some social networking systems, a user may simply follow the web postings of another user (e.g., text-based messages posted by the other user). Social networking sites typically use terms such as “friend,” “like,” or “follow” to describe a user's association with another user, content, or entity. For example, a user may elect to follow a particular celebrity or a restaurant. In doing so, the user may, for example, receive offers (e.g., advertisements or promotions), images or other like content, or be able to view or receive the postings from the celebrity or restaurant.

Filtering criteria may include, for example, a rating, a popularity, a user-defined selection, a seniority, and a social network. The comment feed may be filtered according to one or more of these (or other) filtering criteria. A slot may be deemed available after filtering according to the social network of a user. A rating may describe, for example, a system that assigns a value (e.g., rates) one or more comments in a comment feed (e.g., for quality or relation to the content being provided, i.e., relevancy). Popularity may be based on a voting system that, in a simplistic configuration, compares the number of likes to dislikes that a particular comment has received. Seniority may describe a temporal arrangement of comments (e.g., the oldest comment appears first ahead of the next oldest comment, etc.).

In one or more embodiments described herein, a social network associated with a comment source may be identified. The comment source may, for example, be a user. The comment feed may be filtered according to the social network. For example, the comment feed may display comments from those individuals who belong to the social network of the user who initiated playback of the content. Further, an available slot may be determined based on the filtered comment feed. Filtering may be performed on a comment source profile in a social network. For example, a user (e.g., comment source) profile information may be used to filter a comment feed or determine the availability of a slot.

The comment feed may be adapted, filtered, and adjusted both on the fly, in response to specified factors, prior to comment submission, or while determining an available slot. For example, multiple comments may exist at the reference. Each comment may occupy a slot for the reference. For example, a comment feed may allow three comments to be visible at any specific reference point. Once more than three comments have been submitted that overlap the specific reference point, the comment feed may, for example, scroll the first three comments to display the fourth comment if the first of the three comments has passed a determined minimum display length. Thus, a threshold number of comments displayable in the comment feed at the reference point may be determined. The threshold number may be determined, for example, by the size of the comment feed window, configured by a user or system administrator, or fixed by software operable on the website.

Returning the FIG. 10, the content management system 12, for example, may perform a filtering function prior to or while providing comments. For example, it may filter based on profile information 39, for example, the user's age, gender, and stated interests. The profile information 39 may also include preferences, or the content management system 12 may define dynamic filtering criteria. Filtering may also be performed on the comment type or user type. For example, users may prefer to receive comments only from cast members. Filtering can utilize any combinations of data accessible to, for example the content management system 12, and is not limited to profile information. The filter criteria may also be set prior to submitting a comment. For example, cast members may specify that their comments are only sent to VIP members. This may be done according to predefined settings, or at the time of comment submission (e.g. extra filtering information entered into interface 70). Filtering may also be based on determining similarities between users based on the profile information, number of comments, country, language, content type, etc.

An available slot may be determined in a variety of ways (some described above) and, in some configurations, it may have a threshold number of comments per reference point. For example, an available slot may exist where the number of comments is below the threshold number at the reference point. The determination of an available slot may thus be based on the number of comments at the reference point (e.g., whether the number of comments below a threshold number).

A duration of a comment may be fixed or varied (e.g., adapted). For example, a duration may be determined based on the number of comments already in the comment feed. For example, a server may calculate that comments must have less duration to increase the number of comments visible to users. This calculation may be performed in real-time or be based on a predetermined volume or density of comments. For example, if the comment feed has greater than 100 comments, duration may be reduced to three second. In another example, if the comment feed has any reference for which more than 10 comments have been submitted, the duration may be altered. Duration may also be based on the popularity of the content being provided. For example, a video that is receiving an exponentially increasing number of requests may be determined to be popular or trending. The system may anticipate that the video is likely to receive many comments and, therefore, reduce the maximum duration of comments. The duration of individual comments may also be adjusted (e.g., independent of other comments in the same comment feed). For example, if a particular reference of a video is receiving many comments, in some configurations, the duration of one or more comments proximal to the reference may be reduced to accommodate more comments. Duration may also be adjusted based on one more of the filtering criteria mentioned above as well.

Various embodiments of the disclosed subject matter can alter a comment feed based on at least one type of a submitted comment and at least one type of an existing comment in the feed. Examples of a comment type include the author of the content. The author can be the actual or purported author, e.g., the actual person who writes and/or submits the comment or a character in a video that is identified as the author of the comment, even though the actual such comment may be authored by a cast member or by a script writer. The comment type can also be based on the content of the comment. For example, the type can be based on the format of the comment (video, audio, text, etc.), the meaning of the comment (e.g., an alert, a advertisement, the occurrence of certain keywords and/or fragments and/or sentences in the comment), etc.) A type can also be based on the source of a comment, e.g., by network address, by source system name, device identifier, etc. A type can also be based on the object of the comment, e.g., a particular event, character, product, etc.

A user can submit a submitted comment for display in the comment feed at a submitted reference point. The comment feed can already be populated with one or more existing comments. A comparison can be made between one or more types of the submitted comment and one or more types of an existing comment that is displayed at the submitted reference in the comment feed to obtain a comparison result. For example, the author of the submitted comment can be compared to the author of the existing comment. The author of the submitted comment could be a cast member or the submitted comment could be authored by a scriptwriter of the video to purport to be from a character in the video being commented upon. If the existing comment is authored by an ordinary viewer, then the submitted comment can be determined to take priority over the existing comment, based on the comparison result. In that case, the existing comment can be moved, deleted or otherwise modified so that the submitted comment can occupy at least a part of the comment feed formerly (before the modification) occupied by the existing comment.

In various embodiments, the comparison result may be based upon a combination of types of comments. Thus, for example, a submitted comment that is an alert and has the keyword “Urgent” can be determined to take priority over an existing comment authored by a character unless the character comment includes the keyword “product.” Any combination of one or more submitted and existing comment types can be used as the basis for establishing the priority of a submitted comment in relation to an existing comment.

According to an embodiment, a system is disclosed that may include a database for storing video (or other content such as audio or multimedia) and a comment feed. The system may have multiple databases. For example, one database may store or provide the content (e.g., video, audio, or multimedia) and another database may store or provide the comment feed. The comment feed may comprise a variety of data types (e.g., video, audio, image, multimedia, and text). A processor may be connected to the database and be configured to provide the video (or other content) and the comment feed. The processor, for example, may belong to a server. It may receive a submitted comment with a submitted reference that corresponds to at least one point in the video. The processor may determine that an existing comment is not displayed in the comment feed at the submitted reference during the video (or other content). It may add the submitted comment to the comment feed to be displayed at the submitted reference. The system may provide the updated comment feed that includes the submitted comment.

In an embodiment, a system is disclosed that may include a database for storing video (or other content such as audio or multimedia) and a comment feed. The system may have multiple databases. For example, one database may store or provide the content (e.g., video, audio, or multimedia) and another database may store or provide the comment feed. The comment feed may comprise a variety of data types (e.g., video, audio, image, multimedia, and text). A processor may be connected to the database and be configured to provide the video (or other content) and the comment feed. The processor, for example, may belong to a server. It may receive a submitted comment with a submitted reference that corresponds to at least one point in the video. The processor may be configured to determine that an existing comment is displayed in the comment feed at the submitted reference during the video and to determine a proximate reference to the submitted reference at which an existing comment is not displayed. The processor may add the submitted comment to the comment feed to be displayed at the proximate reference. The system may provide the updated comment feed that includes the submitted comment.

In an embodiment, a system is disclosed that may include a database for storing video (or other content such as audio or multimedia) and a comment feed. The system may have multiple databases. For example, one database may store or provide the content (e.g., video, audio, or multimedia) and another database may store or provide the comment feed. The comment feed may comprise a variety of data types (e.g., video, audio, image, multimedia, and text). A processor may be connected to the database and be configured to provide the video (or other content) and the comment feed. The processor, for example, may belong to a server. It may receive a submitted comment with a submitted reference that corresponds to at least one point in the video. It may determine a duration for the submitted comment. The processor may determine an available slot for the comment. The available slot may include a range of reference points that includes the submitted reference and does not include any reference point at which an existing comment is displayed in the comment feed. The processor may add the submitted comment to the comment feed to be displayed in the available slot. The system may provide the updated comment feed that includes the submitted comment.

According to an embodiment, a system is disclosed that may include a database for storing video (or other content such as audio or multimedia) and a comment feed. The system may have multiple databases. For example, one database may store or provide the content (e.g., video, audio, or multimedia) and another database may store or provide the comment feed. The comment feed may comprise a variety of data types (e.g., video, audio, image, multimedia, and text). A processor may be connected to the database and be configured to provide the video (or other content) and the comment feed. The processor, for example, may belong to a server. It may receive a submitted comment with a submitted reference that corresponds to at least one point in the video. It may determine a duration for the submitted comment. The processor may be configured to determine a nearby slot for the comment. The nearby slot may include a range of reference points that does not include the submitted reference, does not include any reference point at which an existing comment is displayed in the comment feed and includes the reference point that is closest to the submitted reference point and at which no existing comment is displayed in the comment feed. The processor may add the submitted comment to the comment feed to be displayed in the nearby slot. The system may provide the updated comment feed that includes the submitted comment.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
providing video and a comment feed;
receiving a submitted comment with a submitted reference that corresponds to at least one point in the video;
determining at least one type of the submitted comment;
determining that an existing comment is displayed in the comment feed at the submitted reference during the video;
determining at least one type of the existing comment;
comparing the at least one type of the submitted comment with the at least one type of the existing comment to obtain a comparison result; and
replacing the existing comment with the submitted comment based upon the comparison result.

2. The method of claim 1, further comprising:
determining a proximate reference to the submitted reference at which an existing comment is not displayed; and
adding the submitted comment to the comment feed to be displayed at the proximate reference.

3. The method of claim 1, wherein a type of a comment is based on at least one selected from the group consisting of: an author of the comment, the content of the comment, the source of the comment and the object of the content.

4. A method comprising:
providing video and a comment feed;
receiving a submitted comment with a submitted reference that corresponds to at least one point in the video;
determining a duration for the submitted comment;
determining at least one type of the submitted comment;
determining that an existing comment is displayed at the reference point in the comment feed;
determining at least one type of the existing comment;
comparing the at least one submitted comment type with the at least one existing comment type to obtain a comparison result; and
displaying the submitted comment at the at the reference point in the comment feed based upon the comparison result.

5. The method of claim 4, further comprising:
determining a nearby slot for the existing comment, the nearby slot comprising a range of reference points that does not include the submitted reference, does not include any reference point at which the submitted comment is displayed in the comment feed and includes the reference point that is closest to the submitted reference point and at which no comment is displayed in the comment feed; and
adding the submitted comment to the comment feed to be displayed in the nearby slot.

6. The method of claim 4, further comprising determining a threshold number of comments displayable in the comment feed at the reference point.

7. The method of claim 4, wherein a reference is selected from the group consisting of: a time reference, a video frame, and an event occurring in the video.

8. The method of claim 4, further comprising:
identifying a social network associated with a comment source; and
filtering the comment feed based on a comment source profile in a social network

9. The method of claim 4, further comprising filtering the comment feed to display comments submitted by members of a social network of the comment source.

10. The method of claim 4, wherein the comment feed is filtered according to one or more filtering criteria.

11. The method of claim 10, wherein a filtering criterion is selected from the group consisting of: a rating, a popularity, a user-defined selection, a seniority, and a social network.

12. The method of claim 4, wherein the duration is a fixed length.

13. The method of claim 4, wherein the duration is determined based on one or more factors.

14. The method of claim 13, wherein the one or more factors is selected form the group consisting of: a number of comments already in the comment feed, a popularity of the video, and one or more filtering criteria.

15. The method of claim 4, further comprising adjusting the duration of one or more comments in the comment feed.

16. The method of claim 15, wherein the step of adjusting the duration is based on one or more factors selected from the group consisting of: a number of comments already in the comment feed, a popularity of the video, and one or more filtering criteria.

17. A system comprising:
a database for storing video and a comment feed;
a processor connected to the database, the processor configured to:
receive a submitted comment with a submitted reference that corresponds to at least one point in the video;
determine at least one type of the submitted comment;
determine that an existing comment is displayed in the comment feed at the submitted reference during the video;
determine at least one type of the existing comment;
compare the at least one type of the submitted comment with the at least one type of the existing comment to obtain a comparison result; and
replace the existing comment with the submitted comment based upon the comparison result.

18. The system of claim 17, the processor further configured to:
determine a proximate reference to the submitted reference at which an existing comment is not displayed; and
add the submitted comment to the comment feed to be displayed at the proximate reference.

19. The system of claim 17, wherein a type of a comment is based on at least one selected from the group consisting of: an author of the comment, the content of the comment, the source of the comment and the object of the content.

20. A system comprising:
a database for storing video and a comment feed;
a processor connected to the database, the processor configured to:
receive a submitted comment with a submitted reference that corresponds to at least one point in the video;
determine a duration for the submitted comment;
determine at least one type of the submitted comment;
determine that an existing comment is displayed at the reference point in the comment feed;
determine at least one type of the existing comment;
compare the at least one submitted comment type with the at least one existing comment type to obtain a comparison result; and
display the submitted comment at the at the reference point in the comment feed based upon the comparison result.

21. The system of claim 20, the processor further configured to:
determine a nearby slot for the existing comment, the nearby slot comprising a range of reference points that does not include the submitted reference, does not include any reference point at which the submitted comment is displayed in the comment feed and includes the reference point that is closest to the submitted reference point and at which no comment is displayed in the comment feed; and
add the submitted comment to the comment feed to be displayed in the nearby slot.

22. The system of claim 20, the processor further configured to determine a threshold number of comments displayable in the comment feed at the reference point.

23. The system of claim 20, wherein a reference is selected from the group consisting of: a time reference, a video frame, and an event occurring in the video.

24. The system of claim 20, the processor further configured to:
identify a social network associated with a comment source; and
filter the comment feed based on a comment source profile in a social network

25. The system of claim 20, the processor further configured to filter the comment feed to display comments submitted by members of a social network of the comment source.

26. The system of claim 20, wherein the comment feed is filtered according to one or more filtering criteria.

27. The system of claim 26, wherein a filtering criterion is selected from the group consisting of: a rating, a popularity, a user-defined selection, a seniority, and a social network.

28. The system of claim 20, wherein the duration is a fixed length.

29. The system of claim 20, wherein the duration is determined based on one or more factors.

30. The system of claim 29, wherein the one or more factors is selected form the group consisting of: a number of comments already in the comment feed, a popularity of the video, and one or more filtering criteria.

31. The system of claim 20, the processor further configured to adjust the duration of one or more comments in the comment feed.

32. The system of claim 31, wherein the step of adjusting the duration is based on one or more factors selected from the group consisting of: a number of comments already in the comment feed, a popularity of the video, and one or more filtering criteria.
